(19) United States
(12) Patent Application Publication
(10) Pub. No.: US 2008/0011380 A1
(43) Pub. Date: Jan. 17, 2008

(54) Pipes comprising hydrolysis resistant polyamides

(76) Inventors: Robert B. Fish JR., Parkersburg, WV (US); Marvin M. Martens, Vienna, WV (US); Steven A. Mestemacher, Parkersburg, WV (US); Rolando U. Pagilagan, Parkersburg, WV (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/543,673

(22) Filed: Oct. 5, 2006

Related U.S. Application Data
(60) Provisional application No. 60/724,087, filed on Oct. 6, 2005.

(51) Int. Cl. F16L 9/14

(52) U.S. Cl. 138/140

(57) ABSTRACT

Pipes are provided wherein comprising polyamide compositions having good hydrolysis resistance and that may optionally contain plasticizer. Such pipes are suited for applications transporting hydrocarbons. The pipes of the present invention may be in the form of flexible pipes.

### CROSS REFERENCE TO RELATED APPLICATIONS

This application claims the benefit of priority to U.S. Provisional Application No. 60/724,087, filed Oct. 6, 2005.

### FIELD OF THE INVENTION

The present invention relates to pipes comprising hydrolysis resistant polyamide compositions that may optionally comprise plasticizer. The pipes may be in the form of flexible pipes.

### BACKGROUND OF THE INVENTION

Pipes are used to convey a wide variety of liquids, gases, and fine solids under a wide variety of conditions. Pipes are typically made from metals, polymers, and metal-polymer composite structures, depending on the materials to be conveyed and the conditions the pipes will be subjected to during use. Because they have good chemical resistance, good physical properties, and can be conveniently formed into pipes with a variety of diameters and incorporated into multilayered pipes, polyamides are often a desirable material to use for pipes. Pipes often contain two or more layers of different materials in applications that require combinations of properties that are difficult or costly to obtain from single materials. Such pipes are referred to as “multilayered pipes.” Single- and multilayered pipes have many applications, particularly in the oil and gas industry, where they are used to transport oil and gas from undersea and under-land wells to the surface, across the surface both above and below ground to refineries, to and from storage tanks, etc. However, many applications using single- and multilayered pipes require elevated temperatures. Examples include an undersea oil pipe that comes into contact with hot oil from the earth's interior. Under such conditions, the amide bonds of many polyamides may be susceptible to hydrolysis in the presence of water and the rate of hydrolysis increases with temperature. Hydrolysis of the amide bonds can cause a reduction in molecular weight and concomitant loss in physical properties that can result in failure of the pipe during use. Such a failure can be catastrophic, with the loss of fluid causing undesirable consequences ranging from the impairment of the performance of the device within which the piping is incorporated, to contact of the fluid with the surrounding environment.

Aliphatic polyamides such as polyamide 6,12 or polyamide 11 have been used to make multilayered pipes, but many applications require greater hydrolysis resistance than can be obtained from currently available polyamides.

It would be desirable to obtain a pipe comprising polyamide that has both improved hydrolysis resistance and can be conveniently plasticized to give it the flexibility needed to be useful in many applications. A further object of the present invention is to provide piping, tubing and the like which is readily prepared by conventional means well accepted in the field. A feature of the present invention is that the instant compositions are formable into any of a wide variety of structural designs and configurations. An advantage of the present invention is that these structural components can be further optimized for specialized functions with the addition of an assortment of additives including stabilizers, colorants, molding agents, and the like. These and other objects, features and advantages of the invention will become better understood upon having reference to the following description of the invention.

### SUMMARY OF THE INVENTION

There is disclosed and claimed herein pipes comprising at least one concentric layer comprising a polyamide composition comprising a copolyamide comprising;
(a) repeat units derived from monomers selected from one or more of the group consisting of:
   (i) at least one aromatic dicarboxylic acid having 8 to 20 carbon atoms and/or at least one alicyclic dicarboxylic acid having 8 to 20 carbon atoms and at least one aliphatic diamine having 4 to 20 carbon atoms, and
   (ii) at least one aromatic diamine having 6 to 20 carbon atoms and/or at least one alicyclic diamine having 6 to 20 carbon atoms and at least one aliphatic dicarboxylic acid having 4 to 20 carbon atoms; and
(b) repeat units derived from monomers selected from one or more of the group consisting of:
   (iii) at least one aliphatic dicarboxylic acid having 6 to 36 carbon atoms and at least one aliphatic diamine having 4 to 20 carbon atoms, and
   (iv) at least one lactam and/or aminocarboxylic acid having 4 to 20 carbon atoms;

wherein the copolyamide has a melting point that is less than or equal to about 240° C., at least about 30 μeq/g of amine ends, and an inherent viscosity of at least about 1.2 as measured in m-cresol. The polyamide composition may optionally further comprise plasticizer.

### DETAILED DESCRIPTION OF THE INVENTION

There are a number of terms used throughout the specification for which the following will be of assistance in understanding their scope and meaning. As used herein and as will be understood by those skilled in the art, the terms “terephthalic acid,” “isophthalic acid,” and “dicarboxylic acid/dioic acid” refer also to the corresponding carboxylic acid derivatives of these materials, which can include carboxylic acid esters, diesters, and acid chlorides. Moreover and as used herein, and as will be understood by one skilled in the art, the term “hydrolysis resistant” in conjunction with a polyamide refers to the ability of the polyamide to retain its molecular weight upon exposure to water.

As used herein, the term “pipes” refers to structures defining a cavity therethrough for conducting a fluid, including without limitation any liquid, gas, or finely divided solid. They may have a circular or roughly circular (e.g. oval) cross-section. However more generally the pipes may be shaped into seemingly limitless geometries so long as they define a passageway therethrough. For example suitable shapes may include polygonal shapes and may even incorporate more that one shape along the length thereof. The pipes may further be joined together by suitable means to form T-sections, branches, and the like. The pipes may be flexible or stiff and have a variety of wall thicknesses and (in the event that the pipes are circular in cross section) diameters. The pipes may be in the form of multilayered pipes comprising at least two layers, wherein at least one layer comprises a polyamide composition. The layers are concentric and at least two of the layers are made from different materials. Other layers may comprise other polymeric materials or metals. Polymeric materials include thermoplastic polymers and thermoset polymers such as an epoxy resin. Other layers may be formed from a tape or other wrapping material, which made comprise a polyamide composition, other polymer material, metal, or other material. Other layers may also comprise a polymeric and/or metal mesh or sleeve.

The pipes of the present invention are particularly suitable for use in transporting hydrocarbons, including crude oil, natural gas, and petrochemicals. The hydrocarbons may contain water and/or alcohols.

The pipes of the present invention comprise at least one layer comprising a polyamide composition comprising a copolyamide comprising repeat units (a) that are derived from monomers selected from the group consisting of (i) at least one aromatic dicarboxylic acid having 8 to 20 carbon atoms and/or at least one alicyclic dicarboxylic acid having 8 to 20 carbon atoms and at least one aliphatic diamine having 4 to 20 carbon atoms, and (ii) at least one aromatic diamine having 6 to 20 carbon atoms and/or at least alicyclic diamine having 6 to 20 carbon atoms and at least one aliphatic dicarboxylic acid having 4 to 20 carbon atoms. The copolyamide further comprises repeat units (b) that are derived from monomers selected from one or more of the group consisting of (i) at least one aliphatic dicarboxylic acids having 6 to 36 carbon atoms and at least one aliphatic diamine having 4 to 20 carbon atoms, and (ii) at least one lactam and/or aminocarboxylic acids having 4 to 20 carbon atoms.

By “aromatic dicarboxylic acid” is meant dicarboxylic acids in which each carboxyl group is directly bonded to an aromatic ring. Examples of suitable aromatic dicarboxylic acids include terephthalic acid; isophthalic acid; 1,5-nathphalenedicarboxylic acid; 2,6-nathphalenedicarboxylic acid; and 2,7-nathphalenedicarboxylic acid. Terephthalic acid and isophthalic acid are preferred. By “alicyclic dicarboxylic acid” is meant dicarboxylic acids containing a saturated hydrocarbon ring, such as a cyclohexane ring. The carboxyl group is preferably directly bonded to the saturated hydrocarbon ring. An example of a suitable alicyclic dicarboxylic acid includes 1,4-cyclohexanedicarboylic acid.

By “aromatic diamine” is meant diamines containing an aromatic ring. An example of a suitable aromatic diamine is m-xylylenediamine. By “alicyclic dicarboxylic acid” is meant diamines containing a saturated hydrocarbon ring. Examples of suitable alicyclic diamines include 1-amino-3-aminomethyl-3,5,5,-trimethylcyclohexane; 1,4-bis(aminomethyl)cyclohexane; and bis(p-aminocyclohexyl)methane. Any of the stereoisomers of the alicyclic diamines may be used.

Examples of aliphatic dicarboxylic acids having 6 to 36 carbon atoms include adipic acid, nonanedioic acid, decanedioic acid (also known as sebacic acid), undecanedioic acid, dodecanedioic acid, tridecanedioic acid, and tetradecanedioic acid. The aliphatic diamines having 4 to 20 carbon atoms may be linear or branched. Examples of preferred diamines include hexamethylenediamine, 2-methylpentamethylenediamine; 1,8-diaminooctane; methyl-1,8-diaminooctane; 1,9-diaminononane; 1,10-diaminodecane; and 1,12-diaminedodecane. Examples of lactams include caprolactam and laurolactam. An example of an aminocarboxylic acid includes aminodecanoic acid.

Preferred copolyamides are semiaromatic copolyamides. The copolyamides preferably comprise repeat units (a) that are derived from terephthalic acid and/or isophthalic acid and hexamethylenediamine and repeats units (b) that are derived from one or more of nonanedioic acid and hexamethylenediamine; decanedioic acid and hexamethylenediamine; undecanedioic acid and hexamethylenediamine; dodecanedioic acid and hexamethylenediamine; tridecanedioic acid and hexamethylenediamine; tetradecanedioic acid and hexamethylenediamine; caprolactam; laurolactam; and 11-aminoundecanoic acid.

A preferred copolyamide comprises repeat units (a) that are derived from terephthalic acid and hexamethylenediamine and repeat units (b) that are derived from decanedioic acid and/or dodecanedioic acid and hexamethylenediamine.

The copolyamide has at least about 30 μeq/g of amine ends, or preferably at least about 40, or more preferably at least about 50, or yet more preferably at least about 60 μeq/g of amine ends. Amine ends may be determined by titrating a 2 percent solution of polyamide in a phenol/methanol/water mixture (50:25:25 by volume) with 0.1 N hydrochloric acid. The end point may be determined potentiometrically or conductometrically. (See Kohan, M. I. Ed. Nylon Plastics Handbook, Hanser: Munich, 1995; p. 79 and Waltz, J. E.; Taylor, G. B. Anal. Chem. 1947 19, 448-50.)

The copolyamide has an inherent viscosity of at least about 1.2 as measured in m-cresol following ASTM D5225.

The copolyamide has melting point of less than or equal to about 240° C., or preferably less than or equal to about 230° C., or yet more preferably less than or equal to about 220° C. By “melting point” is meant the second melting point of the polymer as measured according to ISO 11357 and ASTM D3418.

The copolyamide of the present invention may be prepared by any means known to those skilled in the art, such as in an batch process using, for example, an autoclave or using a continuous process. See, for example, Kohan, M. I. Ed. Nylon Plastics Handbook, Hanser: Munich, 1995; pp. 13-32. Additives such as lubricants, antifoaming agents, and end-capping agents may be added to the polymerization mixture.

The polyamide composition used in the present invention may comprise the copolyamide alone or may optionally comprise additives. A preferred additive is at least one plasticizer. The plasticizer will preferably be miscible with the polyamide. Examples of suitable plasticizers include sulfonamides, preferably aromatic sulfonamides such as benzenesulfonamides and toluenesulfonamides. Examples of suitable sulfonamides include N-alkyl benzenesulfonamides and toluenesufonamides, such as N-butylbenzenesulfonamide, N-(2-hydroxypropyl)benzenesulfonamide, N-ethyl-o-toluenesulfonamide, N-ethyl-p-toluenesulfonamide, o-toluenesulfonamide, p-toluenesulfonamide, and the like. Preferred are N-butylbenzenesulfonamide, N-ethyl-o-toluenesulfonamide, and N-ethyl-p-toluenesulfonamide.

The plasticizer may be incorporated into the composition by melt-blending the polymer with plasticizer and, optionally, other ingredients, or during polymerization. If the plasticizer is incorporated during polymerization, the polyamide monomers are blended with one or more plasticizers prior to starting the polymerization cycle and the blend is introduced to the polymerization reactor. Alternatively, the plasticizer can be added to the reactor during the polymerization cycle.

When used, the plasticizer will be present in the composition in about 1 to about 20 weight percent, or more preferably in about 6 to about 18 weight percent, or yet more preferably in about 8 to about 15 weight percent, wherein the weight percentages are based on the total weight of the composition.

The polyamide composition used in the present invention may optionally comprise additional additives such as impact modifiers; thermal, oxidative, and/or light stabilizers; colorants; lubricants; mold release agents; and the like. Such additives can be added in conventional amounts according to the desired properties of the resulting material, and the control of these amounts versus the desired properties is within the knowledge of the skilled artisan.

When present, additives may be incorporated into the polyamide composition used in the present invention by melt-blending using any known methods. The component materials may be mixed to homogeneity using a melt-mixer such as a single or twin-screw extruder, blender, kneader, Banbury mixer, etc. to give a polyamide composition. Or, part of the materials may be mixed in a melt-mixer, and the rest of the materials may then be added and further melt-mixed until homogeneous.

The pipes of the present invention may be formed by any method known to those skilled in the art, such as extrusion. When a multilayered pipe is formed, the polyamide composition used in the present invention may be extruded over one or more additional layers, including polymeric and metal layers. Additional layers may be added to a pipe comprising at least one layer comprising the polyamide used in the present invention by wrapping one or more additional layers around a pipe comprising at least one layer comprising the polyamide used in the present invention. A polymeric layer made form an additional polymeric material may be added to a pipe comprising at least one layer comprising the polyamide used in the present invention by extrusion. The pipes will preferably have sufficient flexibility to allow them to be conveniently stored and transported.

In one embodiment, the pipes of the present invention are flexible pipes used in crude oil production to transport oil from wells. Particularly preferred are undersea flexible pipes used to transport crude oil from undersea wells to the surface. Flexible pipes are often subjected to internal pressure and external stressing. Such pipes are described in U.S. Pat. No. 6,053,213, which is hereby incorporated herein by reference. Such pipes are also described in API 17B and 17J, published by the American Petroleum Institute under the title “Recommended Practice for Flexible Pipe.” Flexible pipe is preferably assembled as a composite structure comprising metal and polymer layers where the structure allows large deflections without a significant increase in bending stresses. At least one layer of the flexible pipe comprises the polyamide composition used in the present invention.

The flexible pipe may be of an unbonded type where the layers may move to a certain degree relative to one another. The layers of a flexible pipe may include a carcass that prevents the pipe from being crushed under outside pressure, which may comprise a fabric tape; an internal sheath comprising a polymer; a pressure vault; one or more armor layers; an anti-collapse sheath; and/or an outer sheath comprising polymer. Not all of these layers need be present and additional layers, such a metal tube that may be corrugated, may also be present. Anti-wear strips may be present between metal layers and may be in the form of a tape wrapped around metal layer beneath it. The anti-wear strips will preferably comprise the polyamide composition used in the present invention. The pressure vault may comprise shaped interlocked metal wires. At least one of the sheath layers may comprise the polyamide composition used in the present invention.

The pipes of the present invention have good hydrolysis resistance and are particularly suitable for use in applications that require conveying crude oil, hydrocarbons, alcohols, and mixtures thereof.

What is claimed is:

1. A pipe comprising at least one concentric layer comprising a polyamide composition comprising a copolyamide comprising;
(a) repeat units derived from monomers selected from one or more of the group consisting of:
(i) at least one aromatic dicarboxylic acid having 8 to 20 carbon atoms and/or at least one alicyclic dicarboxylic acid having 8 to 20 carbon atoms and at least one aliphatic diamine having 4 to 20 carbon atoms, and
(ii) at least one aromatic diamine having 6 to 20 carbon atoms and/or at least one alicyclic diamine having 6 to 20 carbon atoms and at least one aliphatic dicarboxylic acid having 4 to 20 carbon atoms; and
(b) repeat units derived from monomers selected from one or more of the group consisting of:
(iii) at least one aliphatic dicarboxylic acid having 6 to 36 carbon atoms and at least one aliphatic diamine having 4 to 20 carbon atoms, and
(iv) at least one lactam and/or aminocarboxylic acid having 4 to 20 carbon atoms;
wherein the copolyamide has a melting point that is less than or equal to about 240° C., at least about 30 μeq/g of amine ends, and an inherent viscosity of at least about 1.2 as measured in m-cresol.

2. The pipe of claim 1, wherein repeat units (b) are derived from decanedioic acid and/or dodecanedioic acid, and hexamethylenediamine.

3. The pipe of claim 1, wherein the aliphatic dicarboxylic acids of monomers (iii) are selected from one or more of nonanedioic acid, decanedioic acid, undecanedioic acid, dodecanedioic acid, tridecanedioic acid, and tetradecanedioic acid, and wherein the aliphatic diamine of (iii) is hexamethylenediame.

4. The pipe of claim 1, wherein the lactam and/or aminocarboxylic acid is at least one of laurolactam, caprolactam, and 11-aminoundecanoic acid.

5. The pipe of claim 1, wherein the copolyamide is present in about 80 to about 99 weight percent and further comprising and about 1 to about 20 weight percent of a plasticizer, wherein the weight percentages are based on the total weight of the composition.

6. The pipe of claim 5, wherein the plasticizer is a sulfonamide.

7. The pipe of claim 5, wherein the plasticizer is one or more of N-butylbenzenesulfonamide, N-(2-hydroxypropyl)benzenesulfonamide, N-ethyl-o-toluenesulfonamide, N-ethyl-p-toluenesulfonamide, o-toluenesulfonamide, and p-toluenesulfonamide.

8. The pipe of claim 1, wherein the polyamide composition further comprises one or more of thermal, oxidative, and/or light stabilizers; mold release agents; colorants; and lubricants.

9. The pipe of claim 1, wherein the copolyamide has at least about 40 μeq/g of amine ends.

10. The pipe of claim 1, wherein the copolyamide has at least about 50 μeq/g of amine ends.

11. The pipe of claim 1, wherein the copolyamide has at least about 60 μeq/g of amine ends.

12. The pipe of claim 1, wherein the copolyamide has a melting point of less than or equal to about 230° C.

13. The pipe of claim 1, wherein the copolyamide has a melting point of less than or equal to about 220° C.

14. The pipe of claim 1, in the form of a multilayered pipe.

15. The pipe of claim 1, wherein the pipe is in the form of an undersea oil pipe.

16. The pipe of claim 1, wherein the pipe is in the form of a flexible pipe.
